(19) United States
(12) Patent Application Publication
(10) Pub. No.: US 2016/0148516 A1
(43) Pub. Date: May 26, 2016

(54) Sustained Learning Flow Process

(71) Applicants: Paul Senn, Salem, MA (US); James Stone, Reading, MA (US); Joshua Hoffman-Senn, Swampscott, MA (US)

(72) Inventors: Paul Senn, Salem, MA (US); James Stone, Reading, MA (US); Joshua Hoffman-Senn, Swampscott, MA (US)

(21) Appl. No.: 14/918,505

(22) Filed: Oct. 20, 2015

Related U.S. Application Data
(60) Provisional application No. 62/082,264, filed on Nov. 20, 2014.

(51) Int. Cl. G09B 5/02; G06Q 30/02; H04L 29/08

(52) U.S. Cl. CPC G09B 5/02; H04L 67/02; H04L 67/22; G06Q 30/0269

(57) ABSTRACT

This invention is about a sustained learning flow process making e-learning and advertising more efficient and effective by enabling the personalization narratives to be delivered to the user that combine e-learning and advertising content. The invention makes itself aware of the user and his or her needs, skills, interests, and many other aspects to present the user with advertisements and e-learning content blended together and delivered to the user according to the multiple narrative flows, telling the user a multi-faceted story which is relevant to both e-learning goals and advertising preferences, as opposed to traditonal online ads devoid of personalized e-learning content. This invention combines the recent developments in e-learning and online advertising space in a unique manner to implement this Sustained Learning Flow Process.

### RELATED U.S. APPLICATION DATA

Provisional application No. 62/082,264 filed on Nov. 20, 2014.

### CROSS-REFERENCE TO RELATED APPLICATIONS

This application claims the benefit of U.S. Provisional Application No. 62,082,264, filed on Nov. 20, 2014.

### BRIEF SUMMARY OF THE INVENTION

This invention relates to sustained learning flow process for delivering personalized e-learning content blended together with targeted user advertisements, combining techniques available and in use in the current advertising and e-learning industries, in a unique manner to deliver blended content in a narrative sequence.

In the online advertising industry, there has been a constant stream of technology development and research to learn various details about the consumer to target the consumer with ads, which are most relevant to consumer's needs, skills, interests, position in life, and other aspects. In fact if allowed and possible, advertisers would like to know every detail of the individual using the internet (via mobile device or otherwise) such as age, gender, location, socio-economic status, what they have purchased recently, occupation, hobbies, websites they visit, marital status, etc. Advertisers have worked with the companies who provide online content (through websites and mobile apps) to gain access to this information) to collect this information to target the consumer with the appropriate advertisement effectively. Many approaches have been developed with both technical and non-technical aspects, including cookie tracking, user opt-in (where the user provides personal info in exchange for some benefit), data mining, site categorization (if a user is on a music instruction site they are good candidates for ads for instruments, etc). A good example of the combination of these techniques is implemented by one of the major search engine providers, which offers many free services including mail, document management, and location services in exchange for the ability to gather information about the user and target him or her with ads. Even the content of messages is mined: If you send an email using the mail service and mention “vacuum cleaners” in the body of the message, the user will start seeing ads for vacuum cleaners on websites user visits. Various methods and algorithms have been developed to use the data to create target segments and prospects who are most likely to respond to an ad or offer, it is a trend towards giving the user the control to decide what vendors he or she wants to see advertising and to manage the delivery of content from these advertisers/vendors rather than the advertisers/vendors managing this process.

In the e-learning space, researchers has found that the effectiveness of course content increases with personalization of the course content. Therefore, instead of offering the same course content to every individual, both the content itself and the method of delivery and presentation of the content should be tailored to that individual. An example of this trend is the adaptive MOOC (Massive Online Open Course). To accomplish this personalization, information about the learner is required, including his or her current level of expertise in the domain, preferred methods of learning such as aural, visual, etc., and preferred delivery mechanisms. Another related trend in e-learning is “spaced repetition,” Some research indicates that reinforcement of course concepts “pushed” to the user in small chunks spaced over time increases knowledge retention and comprehension. Technologies and products have been developed which for instance, sends text messages or emails at spaced intervals, which include mini-quizzes and/or content relevant to the user based on where they are in the course and their learning preferences.

The inventors of this invention noted that the current trend in advertisement and e-learning has a common need to personalize the content based on aspects of the individual. It is a common goal in both advertising and e-learning area that there is a desire for knowledge retention. The advertiser wants the consumer to remember the brand while the course content developer wants the user to remember the concepts being taught. Also, both may desire the user to “click through” the content being displayed, i.e. click on a link to either go to the advertisers site to buy something or go to a website relevant to the course. Additionally, there is an obvious need in the e-learning space to present information in an organized sequence to the user over time, with each content segment building on the last. This concept of presenting information in a flow, creating a story personalized to the user over time, applies as well in advertising. This invention combines the research and technologies from these two domains of e-learning and targeted online advertising to a new process that enables anyone who wants to enhance knowledge retention and increase the impact of delivered content through a personalized flow to achieve this goal more efficiently and effectively in both e-learning and online advertising domains than was possible before.

### BRIEF DESCRIPTION OF DRAWINGS

FIG. 1 shows the model where the client requests the e-learning data from the e-learning server in a commonly known as the “pull” method.

FIG. 2 shows the model where the e-learning data is pushed to the client at a periodic interval by the e-learning server in a commonly known as the “push” method.

FIG. 3 shows the architecture block of Sustained Learning Flow (SLF) process and other network entities interfacing to the said SLF process.

FIG. 4 shows steps for blending of different narrative tree flows shown in FIG. 5 and FIG. 6 to deliver content to the user based on user preferences, defined narrative trees, and strategies.

FIG. 5 shows the narrative tree flow for a “running shoe” story.

FIG. 6 shows the narrative tree for French language e-learning flow.

FIG. 7 shows steps for blending of different narrative tree flows shown in FIG. 5 and FIG. 6 to deliver content, integrated with ad and e-learning content, to the user based on the content the user is currently viewing, user preferences, defined narrative trees, and strategies.

### DETAILED DESCRIPTION OF THE INVENTION

The invention being claimed in this application is now described hereinafter with reference to the accompanying drawings, which enables those skilled in the art to appreciate the full scope of this invention and what is claimed in this invention when read in conjunction with both this summary, the detailed description, and any preferred and/or particular embodiments specifically discussed or otherwise disclosed in this application. This invention may, however, be embodied in many other different forms and should not be construed as limited to the embodiments set forth herein,

The process “Sustained Learning Flow” claimed in this application allows the owners of the online “real estate” (e.g. space on website or in mobile application) to display either traditional ads, brief e-learning content customized for the user, or a combination of both, without significant modification to their infrastructure which already enables them to advertise in a manner, which supports multiple intertwined and inter-connected interactions with the consumer, while giving substantial control to the consumer to enable potential connection both within and between advertising and e-learning flows.

The “Sustained Learning Flow” (“SLF”) contrasts itself with the current flows in advertising and “push” e-learning methodologies. At present, in online advertising flows, the site owner sends a request for an ad to an ad server either directly or through an intermediate party. The request includes information about the user and/or a unique identifier, which can be used as a key to look up information about the user. The ad server uses this information along with data showing what the user has already seen and how he or she has responded to it, to match the user with an appropriate ad. In the e-learning world, a sample flow might be based on the principle of “spaced repetition,” where the consumer is presented the same material periodically in “e-learning snippets,” in different forms, which may also consist of mini quizzes on the material with brief questions.

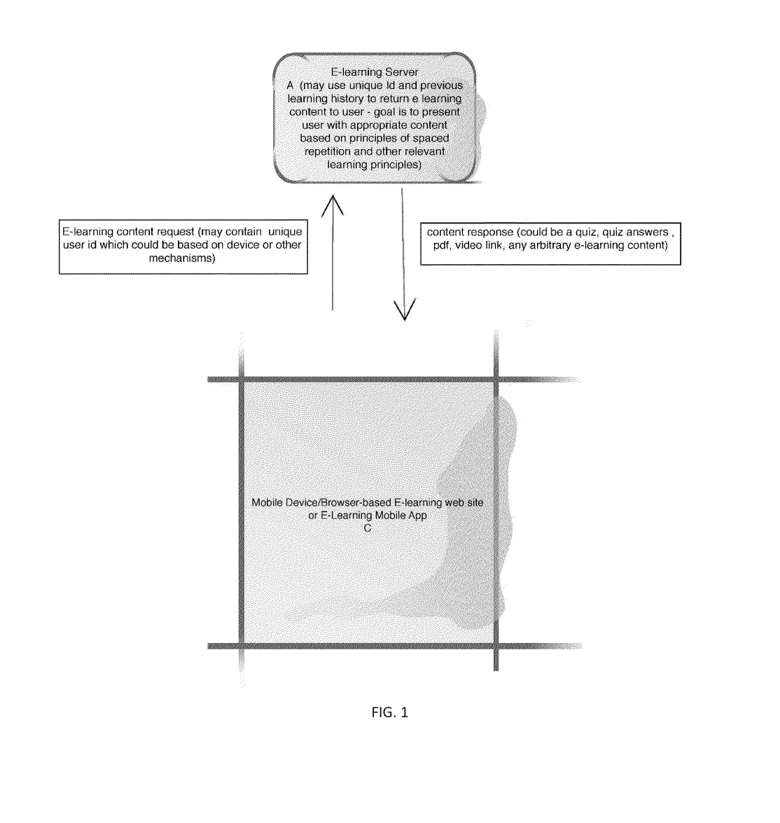

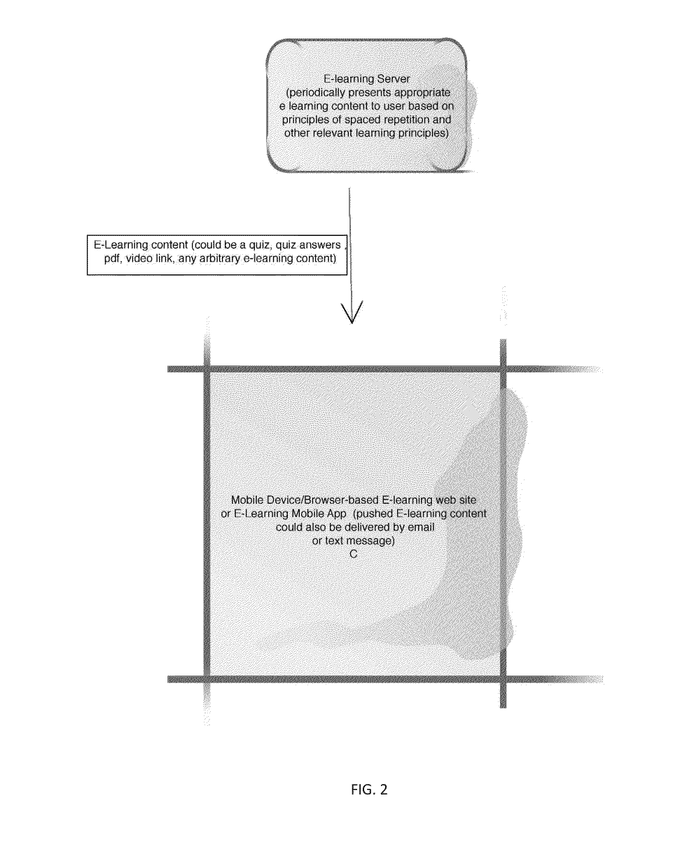

FIG. 1 shows the e-learning flow mechanism. In this pull method, the consumer's device, client device such as client software running on electronic computing devices such as desktop, laptop, mobile devices, tablets etc. requests the e-learning content from the e-learning server, which may use a unique ID and prior learning history to return the e-learning content to the consumer in accordance with the spaced repetition and any other relevant learning principles in place. FIG. 2 shows the e-learning flow mechanism, where the e-learning server pushes the e-learning content to the consumer by the spaced repetition and any other relevant learning principles in use.

The “SLF” process allows the presentation of ads and e-learning snippets to be presented together, returned to the consumer's client device in a single content delivery. The content delivered by the SLF process is personalized to the consumer based on the learned facts about the consumer and/or as customized by the customer and based on separate narrative flows, each proceeding at different rates.

The presentation of content based on the narrative flow is achieved by providing inputs into the decision tree—“Narrative Tree.” inputs to the Narrative Tree include consumer's data comprising of characteristics of the user, history of the user's web use, what advertising and/or other content have been presented to this user either online and/or offline., the user's current position on the e-learning tracks, and how the user has responded either online and/or offline. The Narrative Tree is a decision tree, which is evaluated to determine what is the next episode of appropriate content for a given user. Multiple Narrative Trees may be evaluated to blend the presentation of advertisements and e-learning snippets together in a single content delivery.

Non-personalized advertising streams have been created which attempt to get a narrative going, where a story is created with one ad following another, and currently there are various processes that have been developed in this area. But these are more like “vignettes” than narratives that tell a story over time, and the flow of the narrative (“what happens next”) has not been personalized with content for a given user. The flow is typically the same for everyone in a particular targeted group (for instance an express delivery company ran a series of ads showing a man without his materials giving a presentation and reacting in different humorous ways to his dilemma in each ad). Also, these narratives have not been combined with e-learning push techniques to deliver content that educates the user about something that interests her. The SLF process and the Narrative Tree, which is part of the process SLF, accomplish these objectives.

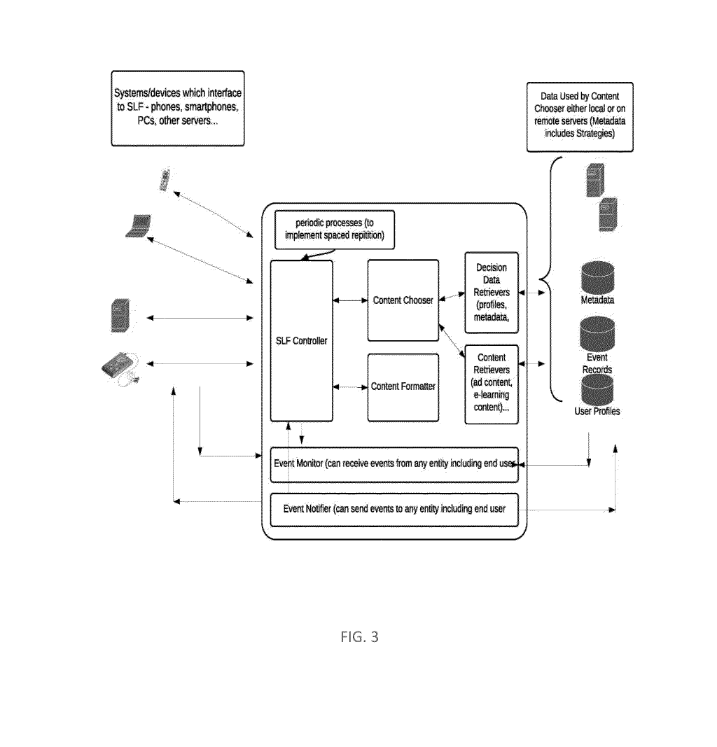

The SLF process as shown in FIG. 3 includes a Content Chooser, which supports multiple Narrative Trees from different sources (e-learning, advertising, and others) and provides a method to employ a user-driven Strategy to determine what content from these trees to deliver at a given moment to a particular user. A user may be at a certain point “X” in one or more advertisers' narrative trees and a certain point “Y” in one or more e-learning narrative trees. After these points are determined, the combined set is evaluated. The final choice is made based on a Strategy that may be for instance “e-Learning Centric” or “Category-Centric” or “Brand-Centric” and the content is formed accordingly.

The narrative flow defined by the advertiser need not and will not proceed in lock step with the narrative flow in e-learning track, and the support of this requirement is one of the unique characteristics of this invention. The SLF process uses content metadata tags and a pattern matching process, allowing for the creation and use of deeply blended content as well as independent content snippets. Narrative Trees are general purpose in nature. Narrative Trees can exist, for-example, based on advertiser content, e-learning content, site content, or application content (e.g. a game content within a mobile app). This abstraction allows for blending of content from different kinds of content sources.

Disclosed herein, in various embodiments, are the various modules and architecture of SLF process running on a digital processing device that is connected to a computer network, wherein said processing device comprises an operating system configured to perform executable instructions and the said SLF process comprises of software modules “SLF Controller”, “Content Chooser”, “Decision Data Retrievers”, “Content Retrievers,” “Content Formatter”, “Event Monitor”, “Event Notifier”, and one or more periodic processes for “spaced repetition” as mentioned in FIG. 3.

SLF Controller module handles request for content which may come from end users using desktop, laptop, mobile phones, tablets or any similar client devices which is able to display advertisement and/or e-learning content delivered by the said SLF process; and/or other servers such as proxy servers which proxy requests from clients and connected through computer networks; and/or periodic processes such as process implementing spaced repetition algorithms; and/or SLF Event monitor. SLF Controller utilizes Content Chooser, Content Formatter, and other related components while processing the received requests.

SLF Controller sends the request to Content Chooser to determine the content to be returned to the user. SLF Chooser takes into account personal characteristics, learning and web history, the prior response by the user to the displayed content, user preferences, and other aspects of individuals as well as factors external to the user to determine what content to return. An essential characteristic of Content Chooser module as compared to other similar components in traditional ad servers is that it can blend content from multiple sources (both advertising and e-learning sources) in a manner which supports delivering content according to multiple narrative flows, where information is presented to the user in sequence over time. The input to Content Chooser module consists of one or more Content Source, Content Retrievers, Content Descriptors, Narrative Trees, User Profiles, Event Record Stores, Strategies, Decision Data Sources, and Decision Data Retrievers.

A Content Source (CS) can be any source of input that provides content to be delivered to the user. It can be either a static data repository or a dynamic feed or interface to a web service. This can be, for instance, a set of files on disk that contain advertising content, a content feed such as a weather feed, or an interface to a web service, which returns the course content (such as a link to an instructional video or quiz segment).

A Content Descriptor (CD) contains the characteristics of the content suitable for the node in the tree. A content descriptor has a unique key, which may be mapped to keys of assets in other systems and data stores, which match the content requirements specified in a given CD.

A Content Retriever (CR) provides the logic necessary to retrieve data from a particular Content Source or set of Content Sources. One or more Content Retrievers can be used to satisfy the requirements in a Content Descriptor,

Narrative Tree (NT) is a representation of a flow that is a sequence of steps with nodes containing Content Descriptors and branches showing decision points where events or other factors can change the flow. For example, an NT could represent an e-learning narrative, which describes a sequence of content snippets to deliver to a user as they go through a course, with branches based on user performance on quizzes and other factors; or an NT could represent an ad campaign, which describes a series of ads to deliver in a certain order to a user, with branches depending on whether they clicked on an ad and other factors. Blended narratives are also possible, such as a combination of e-learning and ad campaigns in one narrative sequence. Other narratives are possible as well such as a political campaign NT, a corporate initiative for employees represented as an NT, or a narrative in any subject domain.

A User Profile (UP) contains all of the information, which the system knows about an individual including the usual characteristics such as gender, age, profession, hobbies, etc., as well as preferences comprising of preferred content type, preferred content chooser Strategy, and preferred mode of content delivery. Preferred content chooser Strategy gives the user more control over the displayed content with SLF than with any traditional advertising or e-learning systems. A User may explicitly choose a content chooser Strategy, or the Strategy could be derived based on user profile data, Analytics may be employed that take into account user behavior captured via the Event Record Store and other available data to pick an appropriate Strategy tailored to that user.

The Event Record Store (ERS) is a database that contains all recorded activities of users that can be captured. These activities may be anonymous—in which case they can be used for analytics but not personalization—or correlated with a user id—in which case the events can be used to personalize suitable content for the a given user. (for examples see “Event Monitor” below). The format of the ERS can be compatible with the Tin Can API (aka “Experience API” or “xAPI”) that is increasingly the preferred standard for e-learning content.

The Strategy provides the method for deciding which content to choose and how to combine content. This is necessary because there could be multiple suitable content choices as a candidate for delivery to a given user at a given time. Strategies could be implemented based on different themes comprising of “Course-Centric,” “Course-Centric-Multi-Node” (combine content from multiple sources), “Category-Centric” or “Theme-Centric” (favor specific content categories or themes), “Vendor-Centric” (favor content from specific advertisers or organizations), “Analytics” (analytics applied to the user profile or actions), or “Shuffle” (entirely random). Note that Narrative Trees have “weights,” which can be used to implement Strategies. An overall weight at the top of the tree can be specified, and weights can be defined at the node level. Weights can have default values, but at run-time when a set of Narrative Trees is being evaluated for a given user, the weights can be dynamically raised or lowered for each tree in accordance with the Strategy chosen by the user, hence causing the Content Chooser to favor one tree over another in accordance with a given Strategy. The user can explicitly choose the Strategy, or the Strategy can be implicitly derived based on user preferences. Strategies can be applied in a fallback method for example “first apply User-defined Strategy if present; else apply Analytics-based Strategy if present; else apply default Strategy.”

A Decision Data Source (DOS) is any source of input, which may be useful for a given Strategy. It can be either a static data repository or a dynamic feed or interface to a web service. This can be for instance, a database of zipcode->income mappings, an interface to a web service which translates IP addresses to countries, a link to service which takes user device IDs as input and returns information about the user gained from other platforms, parameters derived from predictive analytics, or user classification systems, or a news feed.

A Decision Data Retriever (DDR) contains the logic necessary to retrieve data from a given Decision Data Source or set of such sources.

The Content Chooser based on different algorithms selects and blends content to be presented to the user. The user may have requested content directly, or content may have been requested based on the personal preferences or segments derived from analytics.

Content Chooser algorithm is comprised of following steps: (1) determine appropriate Strategy for the target user; (2) determine appropriate Narrative Tree for target user; (3) apply Strategy to selected Narrative Tree to retrieve data required by Strategy from available Data Sources; (4) based on selected nodes, use Content Retriever to retrieve a blended set of one or more content snippets, which meet the criteria specified by Content Descriptor in chosen nodes.

The Content Chooser returns the selected content to HE Controller, which then sends it to Content Formatter for formatting before transmission of the content to the end user.

The Event Monitor module implements the ability to apply events occurring in one context to user activity in a different context. Any external or internal process or application can send events to the Event Monitor. An event is a notification of the occurrence of some action, which may be a relevant input to the Content Chooser. These may be e-learning events, such as the user signing up for a new course or completing an online module. They could be events occurring on the web such as the user entering a blog post, responding in a forum, or posting on a social media site. They could be events occurring in applications running on a mobile device such as the user entering a new level in a game, revealing, or unlocking an achievement in a game, upgrading to a the premium version of an application, or downloading a new application. All of these events could be available in the historical record of user behavior provided in one or more Event Record Stores. The Event Monitor augments the ERS by populating an ERS available to the Content Chooser with real-time notification of events, thereby enabling the Content Chooser to select content that relates directly to events immediately after they occur.

Just as the Content Chooser needs to know about Events as they are occurring, other systems should be notified in real-time of user activity triggered by the SLF Controller. For example, if a user is presented a mini-quiz as a content snippet blended with an ad, the e-learning platform, which has the related course or content can be notified of this event in real time via the Event Notifier. The Event Notifier can accept real-time feeds (for example from other Event Notifiers in a Distributed Architecture), or periodically read an ERS, or receive input via database triggers or other external notification mechanisms.

### EXAMPLES

In this example 1, the user is playing a game on a network connected device and the information is passed to the server running an SLF process. Information passed to the SLF process includes what game is being played arid any relevant events that may have occurred, such as what level the user recently completed. This information, provided to the SLF controller, along with user preferences, defined narrative trees, strategies, and other previously described components will influence the content choices.

In this example 1, the creator of the application has made visible space available in the form of a screen that is displayed in between levels of the game. One possible ad selected by the content chooser is an ad for a tennis shoe that displays a person putting on a running shoe, combined with an e-learning snippet containing a French-English translation. The word being translated is “explosion”, chosen since the last game level ended in an explosion, The app creator had designated the event preceding the e-learning snippet (the completion of a particular level) as an “explosion” event and made that fact available to the SLF controller. While the user is going to a different level in the game, a second ad that will be displayed to the user shows an individual running in the running shoe he put on the previous ad, and below we see a multiple choice quiz question asking the user that of the three French words presented means “Explosion”. During the next game level change, the next ad has the same person running in the running shoe in the ad content, but a new word with French-English translation, which illustrates how the narrative flow for the ad content can proceed at a different rate than the narrative flow for the e-learning content.

In this example, SLF controller was able to retrieve e-learning content related to an explosion because the app creator designated the preceding event as an “explosion” event. If the app maker had not defined the event with such specificity, the SLF Controller would leverage more generic event information to deliver highly relevant content. For example, the SLF Controller may have access to the fact that the state of an achievement has ascended from “revealed” to “unlocked.” The SLF Controller may not have the detail of exactly what the achievement is, but “unlocked” is a standard attribute that applies to achievements across many games. With this information, the SLF Controller could retrieve congratulatory content, such as an e-learning snippet with a French translation of the phrase “nicely done!” or “Congratulations!” Existing tools that have been developed by various app development platforms and system to mark and report success points can be used as input to the SLF Controller.

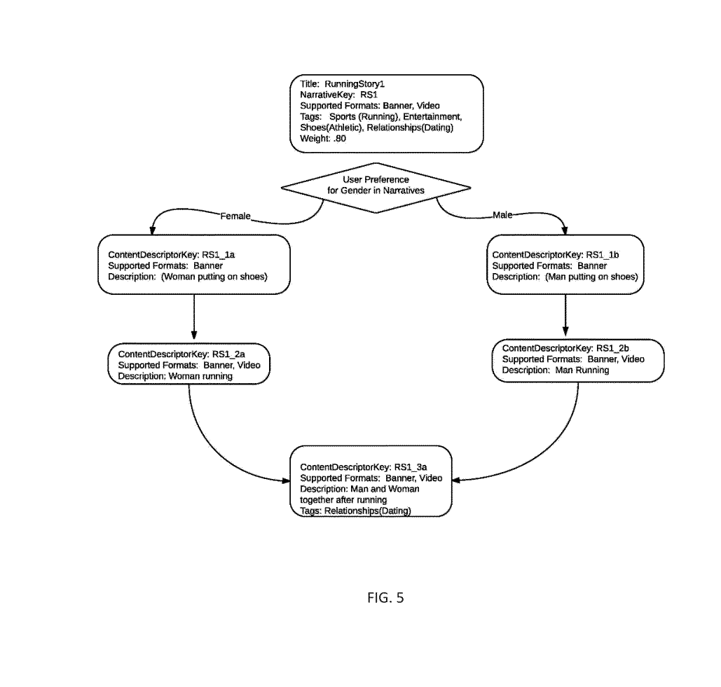

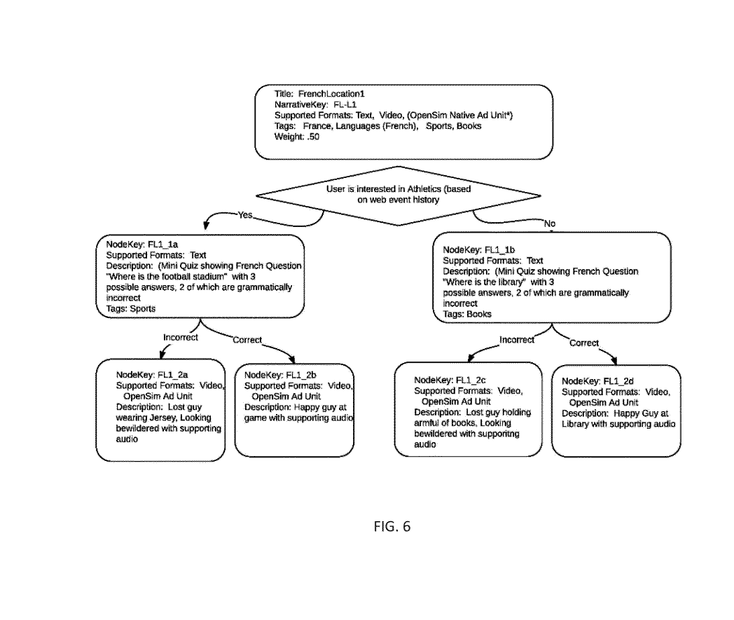

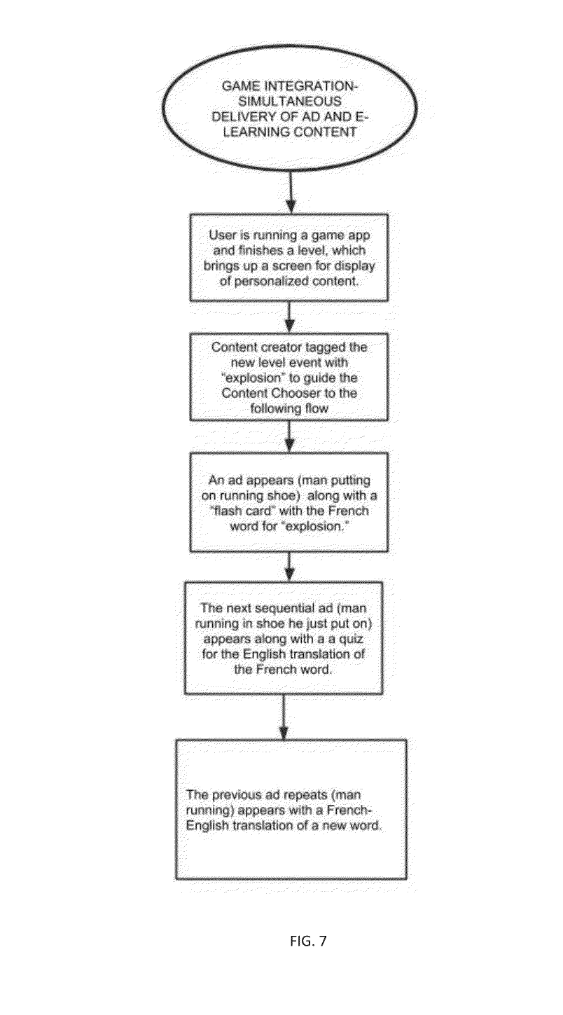

This example also illustrates how the Content Chooser will be influenced by what the user has already seen (known from the Event Record Store). Here, the Content Chooser is aware of the fact that the user has seen the ad content of the man putting on his shoes, and there presents the next node in the tree (the man running), or if the user has already seen the entire sequence, then the entire sequence will be replayed but this time with a different vocabulary word. See FIG. 5, FIG. 6, and FIG. 7 about this example.

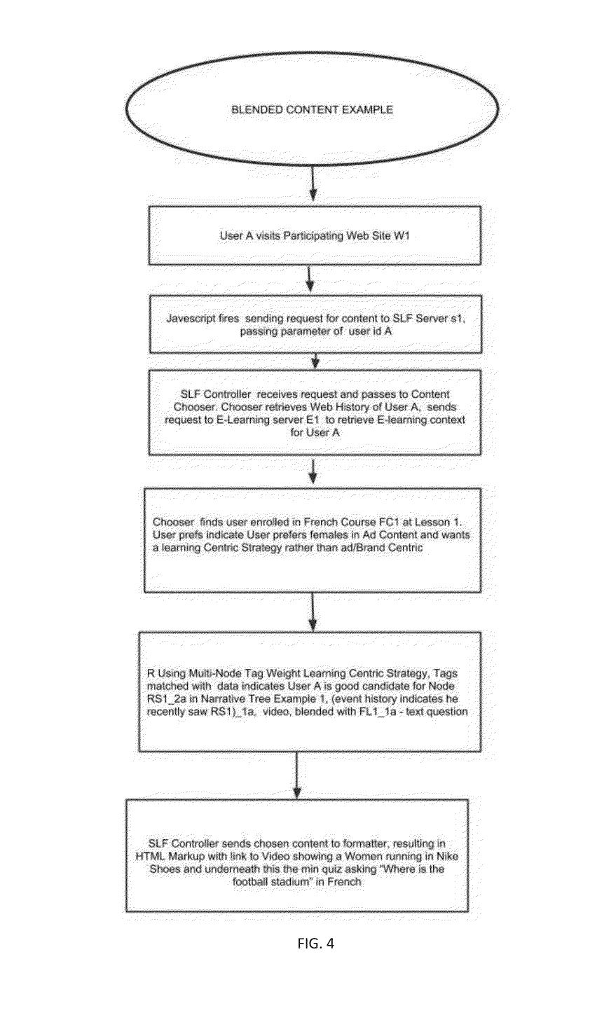

In this example 2, Content developers have developed “themed” content for either advertising or educational purposes. Themes are variations on the presentation of the same content based on the preferences of the users that are captured in various interactions such as polls and surveys. Themes could include learning styles (e.g. visual, auditory, kinesthetic), interests (e.g. outdoors, sports, technology) or any other technique for increasing the engagement level of the user. Each user's profile will contain theme data that is used in the selection of content that will be delivered by the servers. Content developers can perform experiments to determine the effectiveness of themed content and the value of the additional effort required to build multiple versions of the same content. One theme may be associated with multiple content tags, and one content tag can be part of multiple themes. To accomplish this mapping, Themes can be stored in a “theme library” that describes the theme and its associated tag. All content can be optionally associated with one or more themes using this mapping. See FIG. 4, FIG. 5, and FIG. 6 about this example.

In another application of this invention, interested users have elected to let their identity be known to the system to receive tailored e-learning content along with ad content (in a typical advertising-driven model, the users might receive free e-learning content in exchange for being exposed to ads). When the user visits a given website, an ad request is initiated by javascript on the web page the user is visiting. The ad request includes a unique user identifier as well as other characteristics of the user's environment comprising of browser type, network, location. The SLF controller uses the unique id of the user to find all narrative trees currently in progress for the user, and all candidate narrative trees. It then evaluates these trees against a Strategy, and candidate combinations of e-learning snippets and ads are determined. The Content Chooser selects the content, which can be an ad only, an e-learning snippet or a hybrid of ad and e-learning snippet, and the SLF Controller transmits the content to the user after it is formatted by the Content Formatter.

Each time the content is served based on a node in a Narrative Tree, an event is recorded in the Event Record Store. The weight of a node in the Narrative is variable for each user. For example, node weight can be lowered to zero for a given user when he has seen the content a certain number of times over a specified period or based on demonstration of knowledge retention as recorded in the Event Store. Node weights could also be adjusted based on the progress of a user in a spaced repetition program.

We claim:

1. A method comprising receiving a request for content delivery from a client on a computing device connected to the internet with a plurality of other users, and delivering content in single content delivery, from sources each having their own narrative flow and proceeding at different rate where content is based on inputs from various processes, different aspects comprising of user's personal characteristics, user profile, user's learning and interaction history (online and offline) including current and prior content displayed to the user, and prior response to e-learning content, with this information being evaluated and blended through Narrative Flows and a chosen Strategy.

2. A method of claim 1 wherein said sources are all advertising sources.

3. A method of claim 1 wherein said sources are all elearning sources.

4. A method of claim 1 wherein said sources are hybrid of advertising and e-learning source

5. A method of claim 1 further comprising running a web browser on a Desktop, Laptop, Mac, Tablet, or Mobile device as a client to request the content delivery.

6. A method of claim 1 further comprising running an application on desktop, laptop, Mac, Tablet, or Mobile device as a client to request the content delivery.

7. A method of the claim 1 above further comprising receiving inputs from a process implementing periodically spaced repetition.

8. A method of claim 1 above further comprising deciding the content based on real-time activity of the user.

9. A method of claim 8 above further comprising blending content from different sources such that each source refers to the other source and each source reinforces the other source in terms of user knowledge, retention, interest, and other parameters where the source is comprising of advertising campaigns, e-learning tracks, blend of advertising campaigns, e-learning tracks, corporate information campaigns, political campaigns, non-profit campaigns, or any combination of them.

10. A method comprising utilizing user selected strategies to use in the blending of the content from different sources.

11. A method comprising utilizing analytics generated strategies to use in the blending of the content from different sources.

12. A method comprising supporting deep personalization of content through narrative flows allowing insertion of user-specific items comprising of an image, audio, or a video into the delivered content in virtual world environment or via a web browser or application.

13. A method comprising implementing generic narrative flow template, which can be used for substitution of both user specific content and brand specific content in the narrative tree.
